(19) United States
(12) Patent Application Publication
(10) Pub. No.: US 2018/0309663 A1
(43) Pub. Date: Oct. 25, 2018

(54) INFORMATION PROCESSING APPARATUS, INFORMATION PROCESSING SYSTEM, AND INFORMATION PROCESSING METHOD

(71) Applicant: FUJITSU LIMITED, Kawasaki-shi (JP)

(72) Inventors: Eiji Furukawa, Toyohashi (JP); Shusaku Yamanaka, Kawasaki (JP)

(73) Assignee: FUJITSU LIMITED, Kawasaki-shi (JP)

(21) Appl. No.: 15/952,284

(22) Filed: Apr. 13, 2018

(30) Foreign Application Priority Data
Apr. 20, 2017 (JP) 2017-083351

(51) Int. Cl. H04L 12/707; H04L 12/26

(52) U.S. Cl. CPC H04L 45/22; H04L 43/0817

(57) ABSTRACT

An information processing apparatus includes a first communication device configured to have a first communication driver, a second communication device configured to have a second communication driver, a memory, and a processor coupled to the memory and configured to activate the second communication driver based on an identifier of the second communication driver included in a message accepted by the first communication driver, and transfer the message from the first communication driver to the second communication driver.

### CROSS-REFERENCE TO RELATED APPLICATION

This application is based upon and claims the benefit of priority of the prior Japanese Patent Application No. 2017-83351, filed on Apr. 20, 2017, the entire contents of which are incorporated herein by reference.

### FIELD

The embodiments discussed herein are related to an information processing apparatus, an information processing system, and an information processing method.

### BACKGROUND

In an information processing system, a redundant configuration is formed from apparatus that include two or more communication nodes in order to ensure reliability, and a communication path between the communication nodes or between the apparatus is made redundant.

Further, in order to try to improve a system performance, in recent years, scale out that increases the throughput by increasing the number of pieces of hardware is mainstream rather than scale up that makes the hardware performance high. Therefore, together with system expansion by scale out, also a redundant configuration of a system is increasing.

A related technology is disclosed in Japanese Laid-open Patent Publication No. 2001-14284 or Japanese Laid-open Patent Publication No. 2014-157628.

### SUMMARY

According to an aspect of the embodiments, an information processing apparatus includes a first communication device configured to have a first communication driver, a second communication device configured to have a second communication driver, a memory, and a processor coupled to the memory and configured to activate the second communication driver based on an identifier of the second communication driver included in a message accepted by the first communication driver, and transfer the message from the first communication driver to the second communication driver.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of a configuration of an information processing apparatus;

FIG. 2 is a view depicting an example of a configuration of an inter-node communication system;

FIG. 3 is a view depicting an example of message bypass transfer;

FIG. 4 is a view illustrating an example of a message crossover based on a software process;

FIG. 5 is a view depicting an example of a configuration of an information processing system;

FIG. 6 is a view depicting another example of message bypass transfer;

FIG. 7 is a view depicting an example of a hardware configuration of a communication node;

FIG. 8 is a view depicting an example of a message format;

FIG. 9 is a view illustrating message transfer by a queue-structure (QSTR);

FIG. 10 is a view depicting a state in which message transfer is performed without performing a message crossover;

FIG. 11 is a view depicting an example of a sequence of message bypass transfer;

FIG. 12 is a view illustrating an example of bypass transfer of remote direct memory access (RDMA); and

FIG. 13 is a view illustrating an example of a sequence of bypass transfer of RDMA.

### DESCRIPTION OF EMBODIMENTS

If a failure or the like occurs with an information processing system, a bypass path for allowing bypass transfer of a message is established to recover a redundant configuration of the communication path. In this case, a communication device that is a piece of hardware of a communication driver positioned on the bypass path is not necessarily a same type of a communication device, and there is the possibility that message transfer may be performed between communication drivers of different types of communication devices.

In message transfer between communication drivers of communication devices different in type from each other, since a crossover process of a message is performed on software, the period of time for message transfer is increased.

According to one aspect, the embodiments discussed herein provide an information processing apparatus, an information processing system, and a program that decrease the period of time for message transfer between communication drivers of different types of communication devices.

In the following, embodiments are described with reference to the drawings.

### First Embodiment

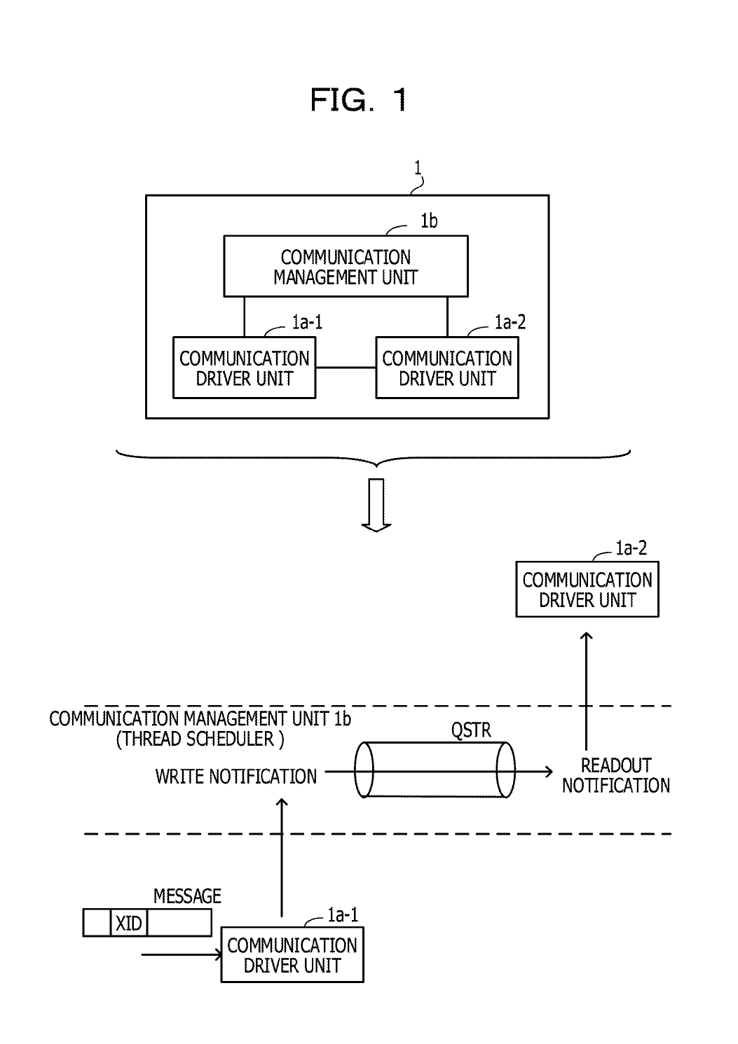

A first embodiment is described. FIG. 1 is a view depicting an example of a configuration of an information processing apparatus. An information processing apparatus 1 includes a controller such as a processor. The controller has functions of communication driver units 1a-1 and 1a-2 (drivers (software)) and a communication management unit (thread scheduler (software)) 1b by execution of software. It is to be noted that the types of hardware involved in the communication driver units 1a-1 and 1a-2 are different from each other.

The communication management unit 1b activates the communication driver unit 1a-2 based on an XID (identifier) of the communication driver unit 1a-2 included in a message to transfer the message from the communication driver unit 1a-1 to the communication driver unit 1a-2.

Here, the communication management unit 1b is a scheduler (software) common to the communication driver units 1a-1 and 1a-2. In this case, the communication management unit 1b performs write notification corresponding to the XID at one end of a queue-structure (QSTR) and calls a readout notification corresponding to the write notification that is waiting at the other end of the QSTR.

Then, the communication management unit 1b activates the communication driver unit 1a-2 in response to a readout notification and transfers the message from the communication driver unit 1a-1 to the communication driver unit 1a-2. It is to be noted that the QSTR is a data structure of a queue that forms a pipe for coupling the write (input) side and the readout (output) side to each other such that it makes it possible to transfer data between threads through the pipe.

In this manner, the information processing apparatus 1 activates the communication driver unit 1a-2 of a transfer destination based on the XID given to the message through the QSTR of the thread scheduler to perform message transfer.

Consequently, since the information processing apparatus 1 makes it possible not to use message crossover on software when message transfer is to be performed between the communication driver units 1a-1 and 1a-2 of hardware of different types, the time for message transfer may be reduced.

### Inter-Node Communication System

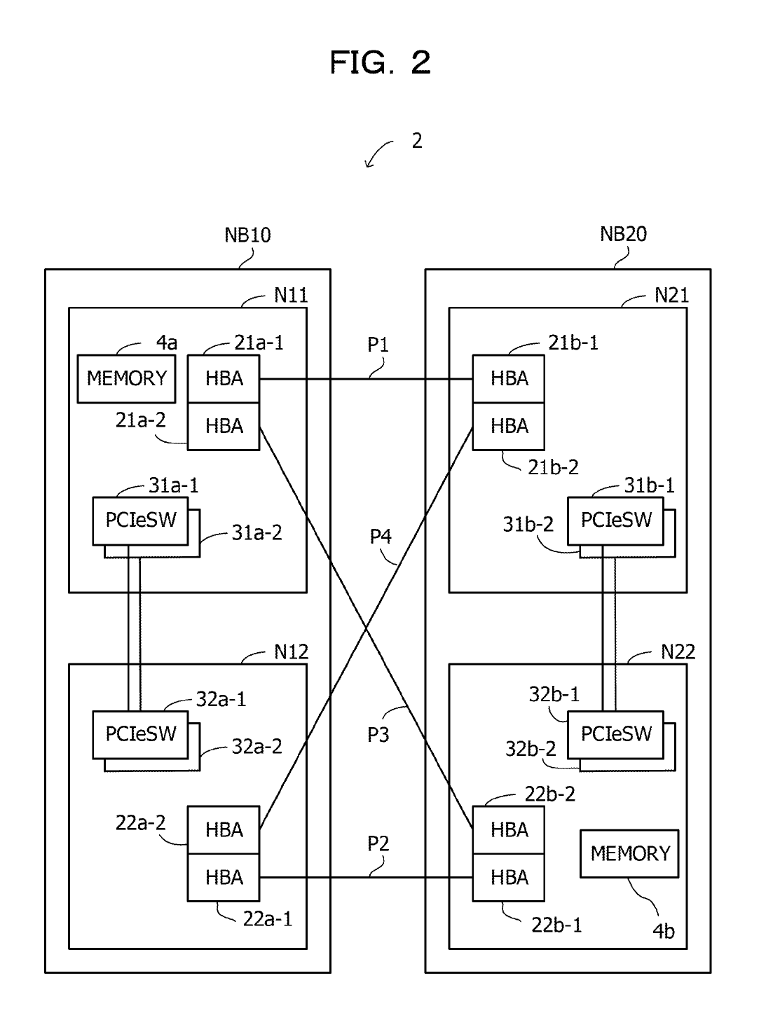

Now, a configuration of an inter-node communication system is described. FIG. 2 is a view depicting an example of a configuration of an inter-node communication system. An inter-node communication system 2 includes a communication node block NB10 and another communication node block NB20.

The communication node block NB10 includes communication nodes N11 and N12, and the communication node block NB20 includes communication nodes N21 and N22.

The communication node N11 includes a host bus adapter (HBA) and HBA driver units 21a-1 and 21a-2, a peripheral component interconnect express switch (PCIeSW) and PCIeSW driver units 31a-1 and 31a-2, and a memory 4a. The communication node N12 includes an HBA and HBA driver units 22a-1 and 22a-2, and a PCIeSW and PCIeSW driver units 32a-1 and 32a-2.

The communication node N21 includes HBA driver units 21b-1 and 21b-2 and PCIeSW driver units 31b-1 and 31b-2. The communication node N22 includes HBA driver units 22b-1 and 22b-2, PCIeSW driver units 32b-1 and 32b-2, and a memory 4b.

In coupling between the communication node blocks NB10 and NB20, the HBA driver unit 21a-1 and the HBA driver unit 21b-1 are coupled to each other by a communication path P1, and the HBA driver unit 22a-1 and the HBA driver unit 22b-1 are coupled to each other by a communication path P2. Further, the HBA driver unit 21a-2 and the HBA driver unit 22b-2 are coupled to each other by a communication path P3, and the HBA driver unit 22a-2 and the HBA driver unit 21b-2 are coupled to each other by a communication path P4.

In coupling between the communication nodes N11 and N12, the PCIeSW driver unit 31a-1 and the PCIeSW driver unit 32a-1 are coupled to each other, and the PCIeSW driver unit 31a-2 and the PCIeSW driver unit 32a-2 are coupled to each other.

In coupling between the communication nodes N21 and N22, the PCIeSW driver unit 31b-1 and the PCIeSW driver unit 32b-1 are coupled to each other, and the PCIeSW driver unit 31b-2 and the PCIeSW driver unit 32b-2 are coupled to each other.

In such a manner as described above, in the inter-node communication system 2, the communication node blocks NB10 and NB20 are coupled to each other through the HBA driver units, and the communication nodes N11 and N12 are coupled to each other and the communication nodes N21 and N22 are coupled to each other through the PCIeSW driver units.

### Message Bypass Transfer

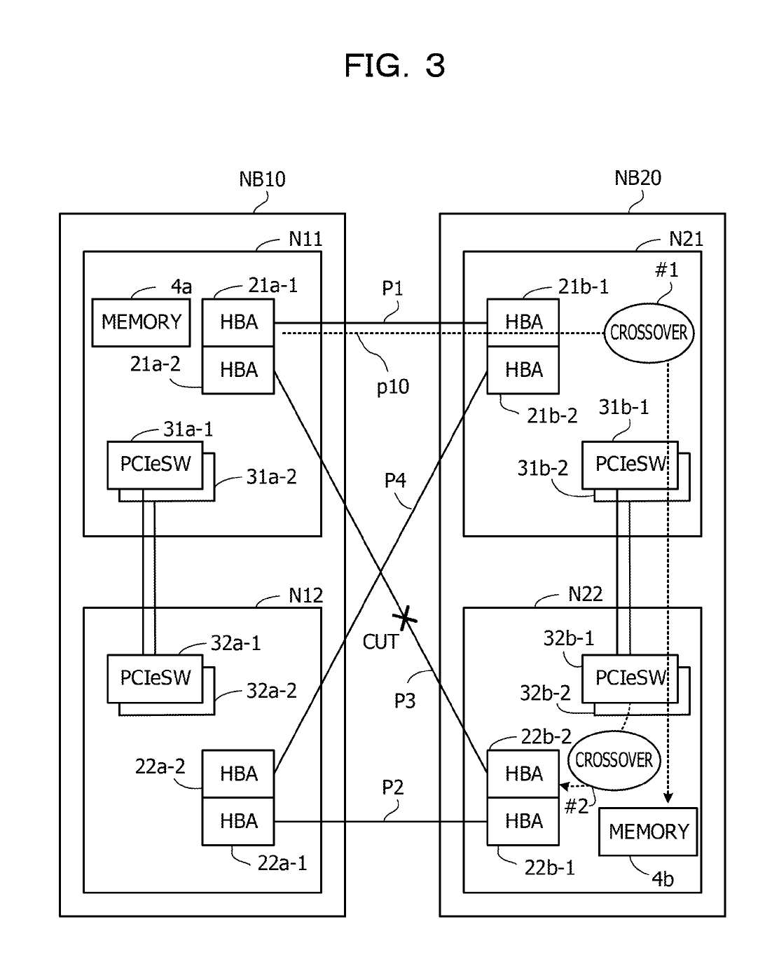

Now, message bypass transfer when a communication path is cut in the inter-node communication system 2 is described. FIG. 3 is a view depicting an example of message bypass transfer.

In ordinary message transfer along the communication path P3, the HBA driver unit 21a-2 transfers a message to the HBA driver unit 22b-2 through the communication path P3, and the message received by the HBA driver unit 22b-2 is stored into the memory 4b.

Here, it is assumed that the communication path P3 between the communication nodes N11 and N22 is cut (for example, by a failure of a port of an HBA driver unit).

If the communication path P3 is cut, in the communication node N11, the HBA driver unit 21a-1 is used to establish a bypass path p10 along which a message is transferred from the HBA driver unit 21a-1 and arrives the message at the memory 4b in the communication node N22.

It is to be noted that, in a communication node that is a start point of message transfer, a bypass path according to a communication path in which a failure occurs is stored as table information.

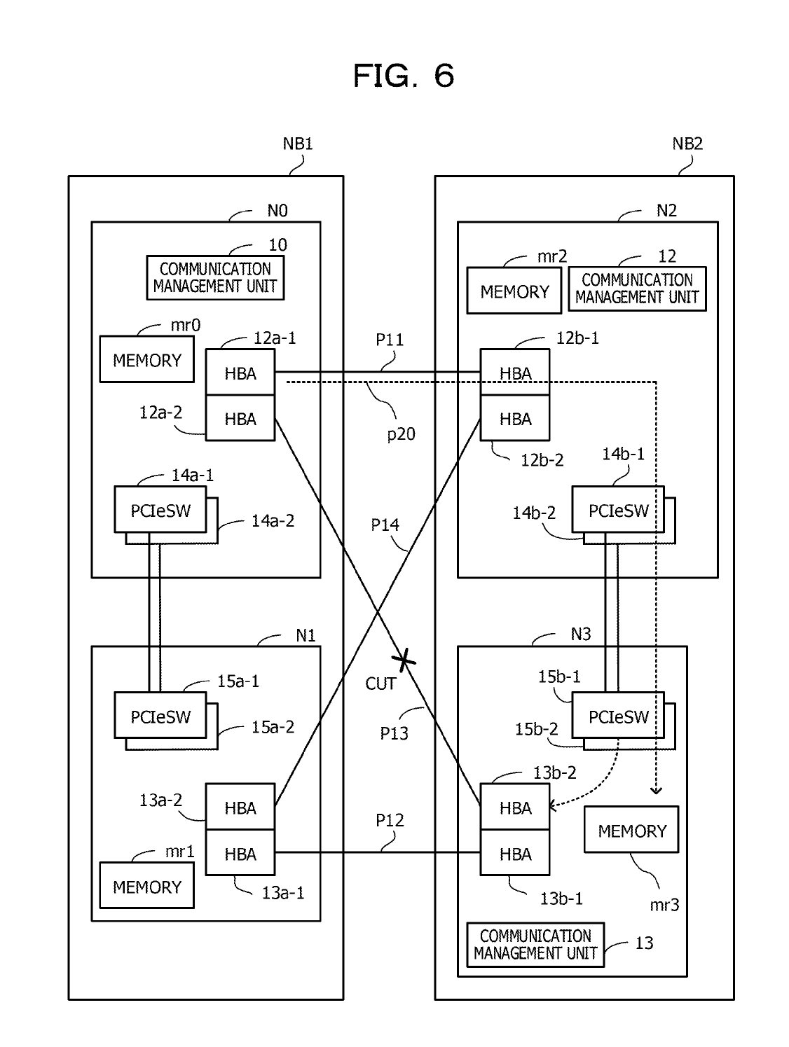

For example, about cutting of a communication path P13, such a bypass path (bypass path p20) along which a message is to be transferred in order of the communication nodes N0, N2, and N3 as depicted in FIG. 6 is stored in advance in the communication node N0 that serves as a start point. Further, for example, about cutting of a communication path P11, a bypass path along which a message is transferred in order of the communication nodes N0, N1, N3, and N2 is stored in advance in the communication node N0 that serves as a start point.

The bypass path p10 allows bypass transfer of a message in order of the communication nodes N11, N21, and N22. The driver units passed by the message along the bypass path p10 are the HBA driver unit 21a-1, the HBA driver unit 21b-1, the PCIeSW driver unit 31b-1, and the PCIeSW driver unit 32b-1 in order. Then, the PCIeSW driver unit 32b-1 stores the message into the memory 4b.

Here, in the bypass path p10, between the HBA driver units 21a-1 and 21b-1, transfer of the message by the driver units of same hardware is performed. Also between the PCIeSW driver units 31b-1 and 32b-1, message transfer by the driver units of same hardware is performed.

On the other hand, in the bypass path p10, between the HBA driver unit 21b-1 and the PCIeSW driver unit 31b-1, message transfer by the driver units of different hardware is performed.

### Message Crossover

In message transfer between driver units of different hardware, message crossover on software is performed. In the example of FIG. 3, crossovers #1 and #2 are performed. The crossover #1 is a message crossover performed when the higher-level software of the communication node N21 receives a message once from the HBA driver unit 21b-1 and transfers the message to the PCIeSW driver unit 31b-1.

Meanwhile, the crossover #2 is a message crossover that is performed when the higher-level software of the communication node N22 transmits the message received by the PCIeSW driver unit 32b-1 to the HBA driver unit 22b-2.

### Message Crossover

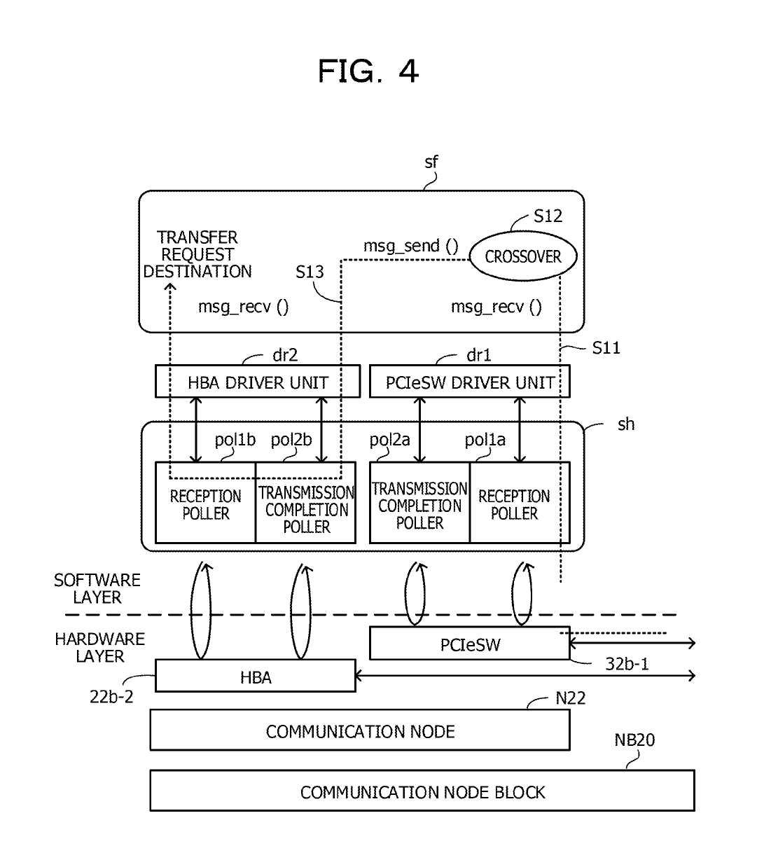

FIG. 4 is a view illustrating an example of a message crossover based on a software process. FIG. 4 depicts an example of the crossover #2. The hardware layer is hierarchized into the communication node block NB20, the communication node N22, the HBA driver unit 22b-2, and the PCIeSW driver unit 32b-1.

Meanwhile, in the software layer, a thread scheduler sh is positioned, and a PCIeSW driver unit (driver software) dr1 and an HBA driver unit dr2 are positioned on the thread scheduler sh. Further, a higher-level software sf is positioned in an upper layer.

The PCIeSW driver unit dr1 includes a reception poller pol1a and a transmission completion poller pol2a in the thread scheduler sh. Reception polling is performed by the reception poller pol1a, and transmission completion polling is performed by the transmission completion poller pol2a.

Meanwhile, the HBA driver unit dr2 includes a reception poller pol1b and a transmission completion poller pol2b in the thread scheduler sh. Reception polling is performed by the reception poller pol1b, and transmission completion polling is performed by the transmission completion poller pol2b.

It is to be noted that the reception polling is polling by which reception reaping (process of generating an interrupt to extract a message from a reception buffer) is performed when inquiry in reception reaping is performed and a given condition is satisfied. The transmission completion polling is polling by which notification of transmission completion is performed when inquiry in transmission completion is performed and a given condition is satisfied.

In the following, a flow of operation when a message crossover is performed is described.

[Step S11] The PCIeSW driver unit 32b-1 receives a message. The message is transmitted to the higher-level software sf through the reception poller pol1a and the PCIeSW driver unit dr1.

[Step S12] The higher-level software sf converts a state msg_recv( ) of the message into another state msg_send( ) to perform a message crossover (it is to be noted that, in the parentheses, a given parameter is designated).

[Step S13] The message of the state msg_recv( ) after the message crossover is transmitted to a transfer request destination through the HBA driver unit dr2, the transmission completion poller pol2b, and the reception poller pol1b.

In this manner, each of the driver units of the communication devices of different hardware such as HBA or PCIeSW has a unique contrivance for transmission completion notification or reception reaping. Therefore, in message transfer between driver units of different communication devices, as described above, a crossover process of a message on software is performed, and the time for message transfer increases.

Taking such a situation as described above into consideration, in a second embodiment described below, a system that performs inter-node communication achieves reduction in message transfer time period by performing message transfer between driver unit apparatus using a thread scheduler.

### Second Embodiment

In the following, an information processing system of the second embodiment is described in detail. First, a configuration of the information processing system is described.

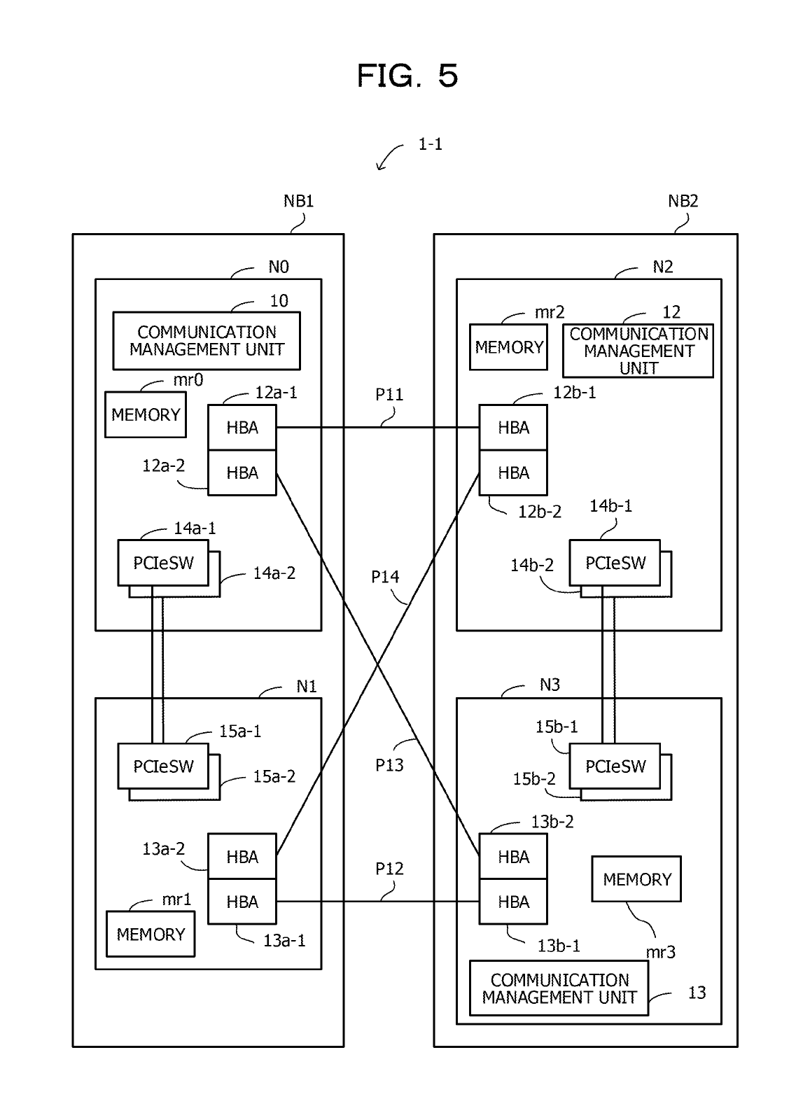

FIG. 5 is a view depicting an example of a configuration of an information processing system. An information processing system 1-1 includes a communication node block NB1 and another communication node block NB2. The communication node blocks NB1 and NB2 correspond, for example, to storage control apparatus that control inputting and outputting of a storage or the like.

The communication node block NB1 includes communication nodes N0 and N1, and the communication node block NB2 includes communication nodes N2 and N3.

The communication node N0 includes a communication management unit 10, HBA driver units 12a-1 and 12a-2, PCIeSW driver units 14a-1 and 14a-2, and a memory mr0. The communication node N1 includes HBA driver units 13a-1 and 13a-2, PCIeSW driver units 15a-1 and 15a-2, and a memory mr1.

The communication node N2 includes a communication management unit 12, HBA driver units 12b-1 and 12b-2, PCIeSW driver units 14b-1 and 14b-2, and a memory mr2. The communication node N3 includes a communication management unit 13, HBA driver units 13b-1 and 13b-2, PCIeSW driver units 15b-1 and 15b-2, and a memory mr3.

In coupling between the communication node blocks NB1 and NB2, the HBA driver unit 12a-1 and the HBA driver unit 12b-1 are coupled to each other by a communication path P11, and the HBA driver unit 13a-1 and the HBA driver unit 13b-1 are coupled to each other by a communication path P12. Further, the HBA driver unit 12a-2 and the HBA driver unit 13b-2 are coupled to each other by a communication path P13, and the HBA driver unit 13a-2 and the HBA driver unit 12b-2 are coupled to each other by a communication path P14.

In coupling between the communication nodes N0 and N1, the PCIeSW driver unit 14a-1 and the PCIeSW driver unit 15a-1 are coupled to each other, and the PCIeSW driver unit 14a-2 and the PCIeSW driver unit 15a-2 are coupled to each other.

In coupling between the communication nodes N2 and N3, the PCIeSW driver unit 14b-1 and the PCIeSW driver unit 15b-1 are coupled to each other, and the PCIeSW driver unit 14b-2 and the PCIeSW driver unit 15b-2 are coupled to each other.

As described above, in the information processing system 1-1, the communication node blocks NB1 and NB2 are coupled to each other through the HBA driver units, and the communication nodes N0 and N1 are coupled to each other and the communication nodes N2 and N3 are coupled to each other through the PCIeSW driver units.

### Message Bypass Transfer

Now, message bypass transfer when a communication path is cut in the information processing system 1-1 is described. FIG. 6 is a view depicting another example of message bypass transfer.

In ordinary message transfer in the communication path P13, the HBA driver unit 12a-2 transfers a message to the HBA driver unit 13b-2 through the communication path P13, and the message received by the HBA driver unit 13b-2 is stored into the memory mr3.

Here, it is assumed that the communication path P13 between the communication nodes N0 and N3 is cut (for example, by a failure of a port of an HBA driver unit). If the communication path P13 is cut, the communication management unit 10 of the communication node N0 detects the communication path failure. Then, the communication management unit 10 generates a message to which the XID is added and causes the HBA driver unit 12a-1 to transfer the message through the bypass path p20.

It is to be noted that the bypass path p20 bypass transfers the message to the communication nodes N0, N2, and N3 in order. The driver units through which the message passes along the bypass path p20 are the HBA driver unit 12a-1, the HBA driver unit 12b-1, the PCIeSW driver unit 14b-1, and the PCIeSW driver unit 15b-1. Then, the PCIeSW driver unit 15b-1 stores the message into the memory mr3.

Meanwhile, in the communication node N2, the HBA driver unit 12b-1 is positioned on the bypass path p20 and receives the message. Here, in the bypass path p20, the HBA driver unit 12b-1 and the PCIeSW driver unit 14b-1 include communication devices of types different from each other.

Therefore, the communication management unit 12 in the communication node N2 activates the PCIeSW driver unit 14b-1 based on the XID of the PCIeSW driver unit 14b-1 given to the message and transfers the message from the HBA driver unit 12b-1 to the PCIeSW driver unit 14b-1.

On the other hand, in the communication node N3, the PCIeSW driver unit 15b-1 and the HBA driver unit 13b-2 include communication devices of types different from each other. Therefore, the communication management unit 13 in the communication node N3 activates the HBA driver unit 13b-2 based on the XID of the HBA driver unit 13b-2 given to the message and transmits the message from the PCIeSW driver unit 15b-1 to the HBA driver unit 13b-2.

### Hardware Configuration

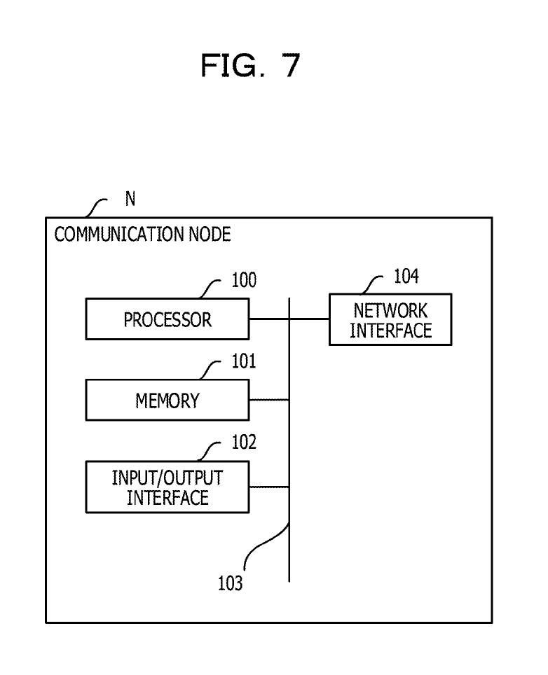

Now, a hardware configuration of a communication node is described. FIG. 7 is a view depicting an example of a hardware configuration of a communication node. Each of the communication nodes N0, . . . , N3 (where they are not distinguished from each other, each of them is referred to as communication node N) has the functions of the information processing apparatus 1 described hereinabove with reference to FIG. 1 and is controlled the whole apparatus by a processor 100. For example, the processor 100 functions as a controller (including a PCIeSW driver unit, an HBA driver unit, and a communication management unit) of the communication node N.

To the processor 100, a memory 101 and a plurality of peripheral apparatus are coupled through a bus 103. The processor 100 may be a multiprocessor. The processor 100 is, for example, a central processing unit (CPU), a micro processing unit (MPU), a digital signal processor (DSP), an application specific integrated circuit (ASIC), or a programmable logic device (PLD). Alternatively, the processor 100 may be a combination of two or more elements of a CPU, an MPU, a DSP, an ASIC, and a PLD.

The memory 101 is used as a main storage device of the communication node N. Into the memory 101, at least some of programs of an operating system (OS) or application programs to be executed by the processor 100 is temporarily stored. Further, in the memory 101, various messages for processing by the processor 100 are stored.

Further, the memory 101 is used also as an auxiliary storage device of the communication node N, and programs of the OS, application programs, and various messages are stored into the memory 101. The memory 101 may include, as an auxiliary storage device, a semiconductor storage device such as a flash memory or a solid state drive (SSD) or a magnetic recording medium such as a hard disk drive (HDD).

The peripheral apparatus are coupled to the bus 103 and include an input/output interface 102 and a network interface 104. The input/output interface 102 has coupled thereto a monitor (for example, a light emitting diode (LED) or a liquid crystal display (LCD)) that functions as a display apparatus that displays a state of the communication node N in accordance with an instruction from the processor 100.

Further, to the input/output interface 102, an information inputting apparatus such as a keyboard or a mouse may be coupled, and the input/output interface 102 transmits a signal sent thereto from the information inputting apparatus to the processor 100.

The input/output interface 102 functions as a communication interface for coupling a peripheral apparatus. For example, the input/output interface 102 allows coupling thereto of an optical drive apparatus that utilizes laser light or the like to perform reading of a message recorded on an optical disk. The optical disk is a portable recording medium on which a message is recorded so as to be readable by reflection of light. As the optical disk, there are a digital versatile disc (DVD), a DVD-random access memory (RAM), a compact disc read only memory (CD-ROM), a CD-recordable (R)/rewritable (RW) and so forth.

Further, the input/output interface 102 allows coupling thereto of a memory device or a memory reader/writer. The memory device is a recording medium in which a communication function with the input/output interface 102 is incorporated. The memory reader/writer is an apparatus that performs writing of a message into or reading out of a message from a memory card. The memory card is a card type recording medium.

The network interface 104 is, for example, a network interface card (NIC), a wireless local area network (LAN) card or the like, and a signal, a message or the like received by the network interface 104 is output to the processor 100.

The processing functions of the communication node N may be implemented by such a hardware configuration as described above. For example, the communication node N may perform message transfer control by the processor 100 executing individual given programs.

The communication node N implements the processing functions of the embodiments discussed herein by executing a program recorded, for example, on a computer-readable recording medium. The program in which the substance of the process to be executed by the communication node N is described may be recorded in various recording media.

For example, the program to be executed by the communication node N may be stored in an auxiliary storage device. The processor 100 loads at least part of the program in the auxiliary storage device into a main storage device and executes the program. Also it is possible to have at least part of the program recorded in a portable recording medium such as an optical disk, a memory device, or a memory card. The program stored in the portable recording medium becomes executable after it is installed into the auxiliary storage device, for example, under the control of the processor 100. Also it is possible for the processor 100 to read out the program directly from the portable recording medium and execute the program.

### Message Format

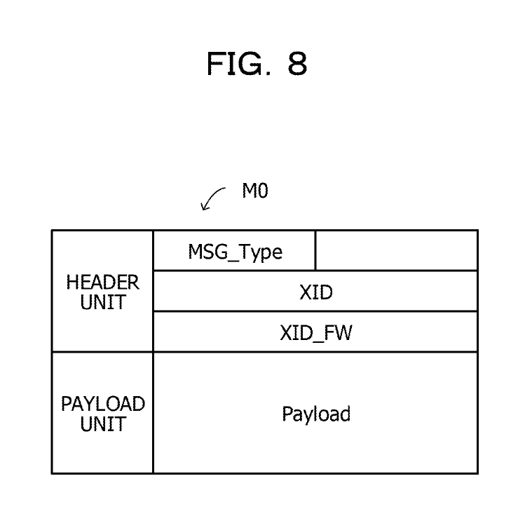

FIG. 8 is a view depicting an example of a message format. A message M0 used in message transfer includes a header part and a payload part. The header part includes MSG_Type (message type), XID (bypass transfer destination identifier), and XID_FW (transfer request destination identifier).

MSG_Type indicates a type regarding, for example, whether or not the message is a message for bypass transfer. XID indicates an identifier of the bypass transfer destination. XID_FW indicates an identifier of the transfer request destination.

### Message Transfer by QSTR

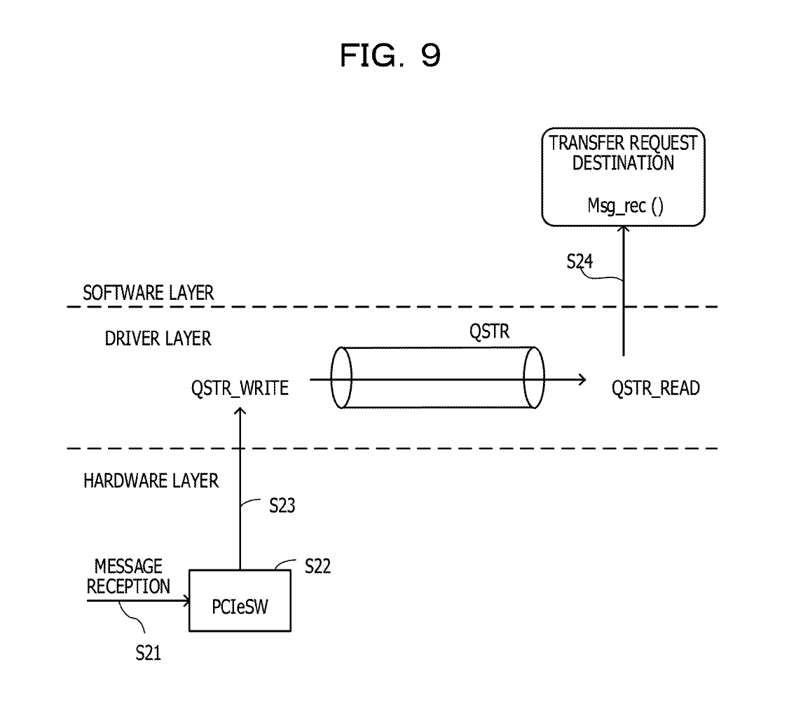

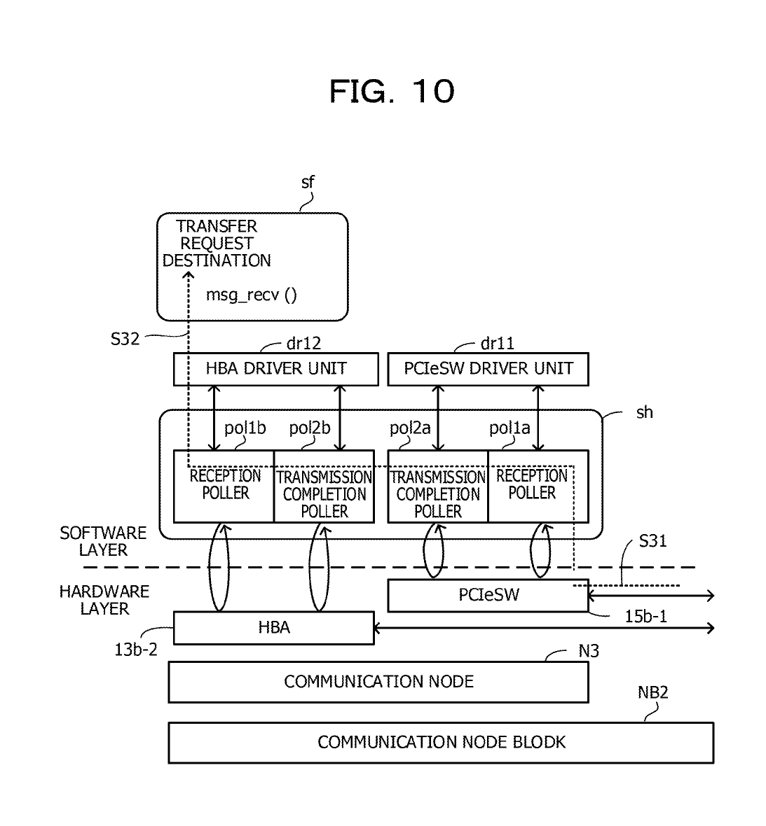

Now, message transfer by QSTR is described with reference to FIGS. 9 and 10. FIG. 9 is a view illustrating message transfer by a QSTR. FIG. 9 depicts a case in which a message received by the PCIeSW is bypass transferred to a transfer request destination through an HBA.

In the hardware layer, a PCIeSW driver receives a message. A communication management unit (thread scheduler) performs 1:1 message transfer based on the QSTR. In the software layer, the message is transmitted to the transfer request destination.

Here, the message transfer based on the QSTR has such a contrivance that a system call of QSTR_READ (readout notification) is placed in a sleep state by the thread scheduler, and if a system call for QSTR_WRITE (write notification) to its own XID is performed, the system call for QSTR_READ is raised from the thread scheduler.

For example, the QSTR causes, if QSTR_WRITE based on the own XID is performed, a queue of QSTR_READ that is in a sleeping state at the communication pipe destination to be raised.

[Step S21] A message arrives at the PCIeSW driver unit.

[Step S22] The PCIeSW driver unit refers to the XID of the message header and starts a message reception process.

[Step S23] The thread scheduler refers to MSG_Type of the message and carries out, if it decides that MSG_Type indicates message bypass transfer, QSTR_WRITE corresponding to the XID in the message.

[Step S24] The HBA driver unit that is waiting bypass transfer is raised from the thread scheduler by this QSTR_WRITE and transmits the message to the transfer request destination.

FIG. 10 is a view depicting a state in which message transfer is performed without performing a message crossover. The hardware layer is hierarchized into the communication node block NB2, the communication node N3, the HBA driver unit 13b-2, and the PCIeSW driver unit 15b-1.

Meanwhile, in the software layer, the thread scheduler sh is positioned, and a PCIeSW driver unit dr11 and an HBA driver unit dr12 are positioned on the thread scheduler sh. Further, a higher-level software sf is positioned in an upper layer.

The PCIeSW driver unit dr11 includes a reception poller pol1a and a transmission completion poller pol2a in the thread scheduler sh, and reception polling is performed by the reception poller pol1a and transmission completion polling is performed by the transmission completion poller pol2a.

The HBA driver unit dr12 includes a reception poller pol1b and a transmission completion poller pol2b in the thread scheduler sh, and reception polling is performed by the reception poller pol1b and transmission completion polling is performed by the transmission completion poller pol2b.

[Step S31] The PCIeSW driver unit 15b-1 receives a message.

[Step S32] Message transfer of the QSTR is performed in the thread scheduler, and the message of the state msg_recv( ) is transmitted to the transfer request destination while a crossover process is not performed by a process of the higher-level software sf.

As described above, in the communication node N, both the HBA driver unit and the PCIeSW driver unit have a transmission completion poller and a reception poller in the thread scheduler and message transfer is performed by the QSTR of the thread scheduler. Further, in this case, one of the HBA driver unit and the PCIeSW driver unit is raised based on the XID given to the message.

In this manner, by execution of message transfer based on the QSTR, message transfer may be performed directly between driver units without performing a crossover process between software. Further, upon message transfer, MSG_Type, XID, and XID_FW are provided in the header part of the message.

Consequently, since the message may be specified as a message for bypass transfer on a bypass path, the message may be transferred, for example, without wrapping the payload of the message on the bypass path upon message bypass transfer, and the processing load may be reduced.

### Sequence of Message Bypass Transfer

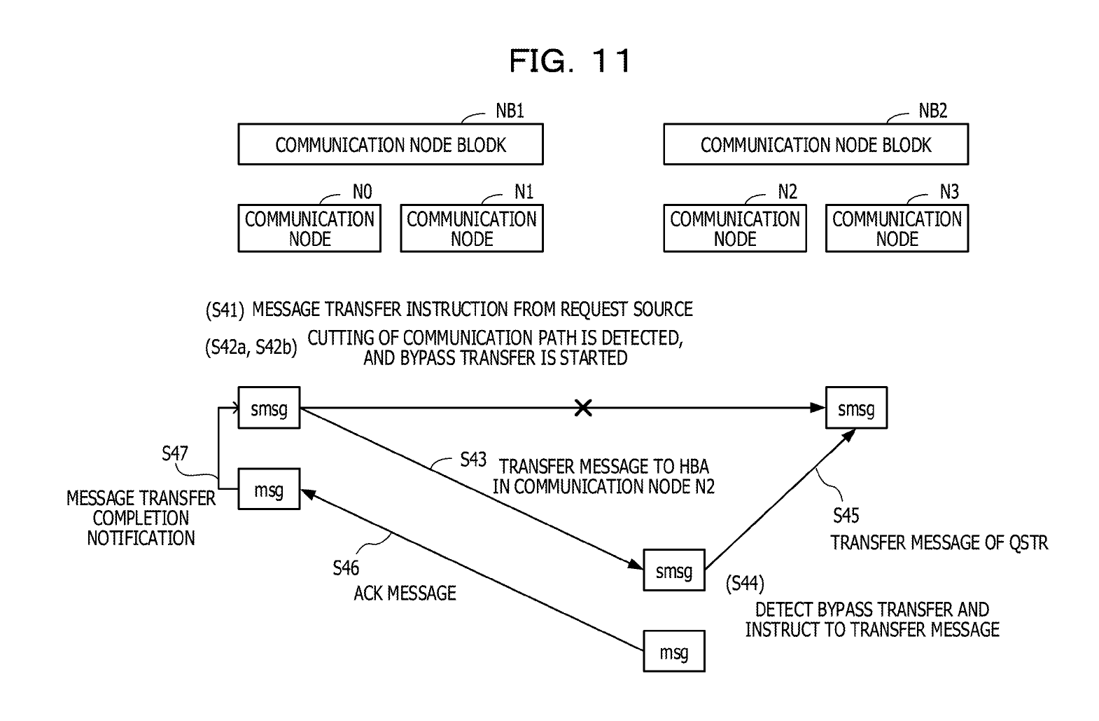

FIG. 11 is a view depicting an example of a sequence of message bypass transfer. It is assumed that the communication path P13 that couples the communication node N0 and the communication node N3 is cut and message transfer is performed along the bypass path p20. It is to be noted that, in FIG. 11, “smsg” denotes a message from a transfer request source, and “msg” denotes a response message.

[Step S41] The communication management unit 10 of the communication node N0 of the message transfer request source instructs the HBA driver unit 12a-2 to transfer a message to the HBA driver unit 13b-2 of the communication node N3.

[Step S42a] The HBA driver unit 12a-2 tries message transfer from the communication node N0 to the communication node N3 through the communication path P13.

[Step S42b] The communication management unit 10 detects, since the communication path P13 is cut, that message transfer using the communication path P13 is not possible and starts bypass transfer.

[Step S43] The communication management unit 10 determines to perform message transfer using the bypass path p20, and the HBA driver unit 12a-1 transfers the message to the HBA driver unit 12b-1 in the communication node N2. At this time, the header part of the message is set, for example, to MSG_Type=REQ_FW, XID=0x00000002, and XID_FW=0x00000003.

[Step S44] The HBA driver unit 12b-1 receives the message. The communication management unit 12 detects that MSG_Type of the received message is the bypass transfer type (REQ_FW). Then, the communication management unit 12 issues an instruction to the HBA driver unit 12b-1 to transfer the message toward the PCIeSW driver unit 14b-1. At this time, the header part of the message is set, for example, to MSG_Type=REQ_FW, XID=0x80000023, and XID_FW=0x00000003.

[Step S45] The communication management unit 12 acquires the QSTR for the PCIeSW driver unit 14b-1 using XID as a key. Then, the communication management unit 12 sets the message to QSTR_WRITE and causes the QSTR_READ of the PCIeSW driver unit 14b-1 to be raised and transfers the message from the HBA driver unit 12b-1 to the PCIeSW driver unit 14b-1.

[Step S46] The HBA driver unit 12b-1 in the communication node N2 transmits a transfer completion message (ACK message) to the HBA driver unit 12a-1 of the communication node N0. At this time, the header part of the message is set, for example, to MSG_Type=ACK_FW, XID=0x00000002, and XID_FW=0x00000003.

[Step S47] The HBA driver unit 12a-1 notifies the communication management unit 10 of message transfer completion.

### Bypass Transfer of Remote Direct Memory Access (RDMA)

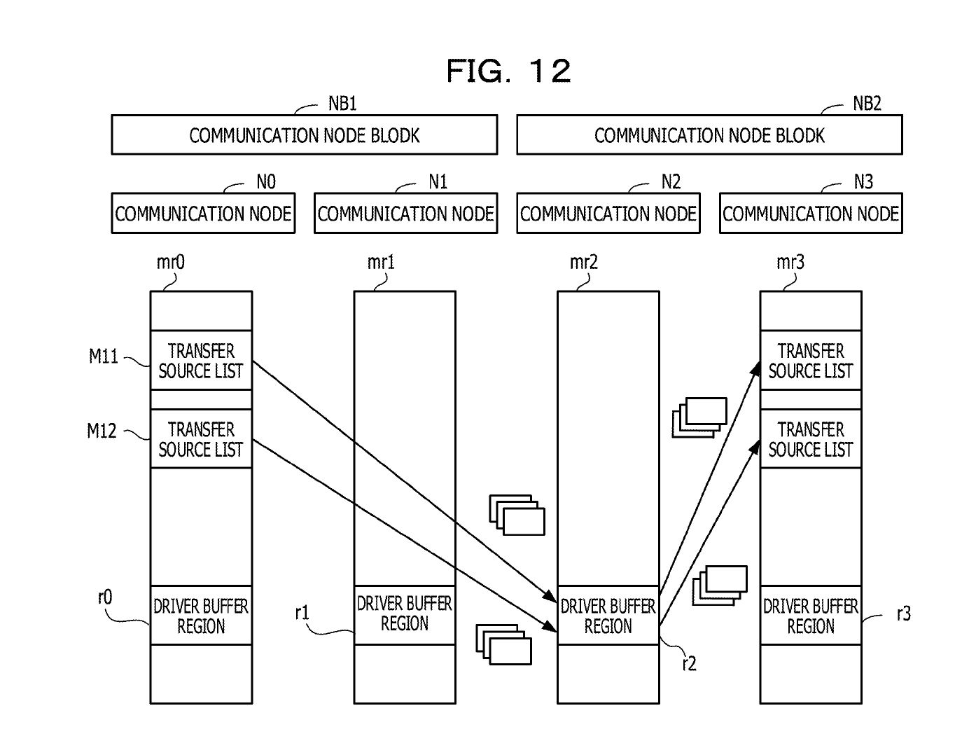

FIG. 12 is a view illustrating an example of bypass transfer of RDMA. The communication nodes N0, N1, N2, and N3 include the memories mr0, mr1, mr2, and mr3 (main memories) as depicted in FIG. 5, individually. The memories mr0, mr1, mr2, and mr3 have driver buffer regions r0, r1, r2, and r3 for storing a message to be transferred from a driver unit, and have a fixed size ensured in the individual communication nodes.

Here, it is assumed that, when transfer source lists M11 and M12 stored in the memory mr0 of the communication node N0 are to be stored into the memory mr3 of the communication node N3 by the RDMA, they are bypass transferred through the communication node N2.

In this case, each of the transfer source lists M11 and M12 is divided into a plurality of parts and stored once into the driver buffer region r2 of the memory mr2 in the communication node N2. Then, the transfer source lists M11 and M12 are read out from the driver buffer region r2 and stored into the memory mr3 in the communication node N3.

### Sequence of Bypass Transfer of RDMA

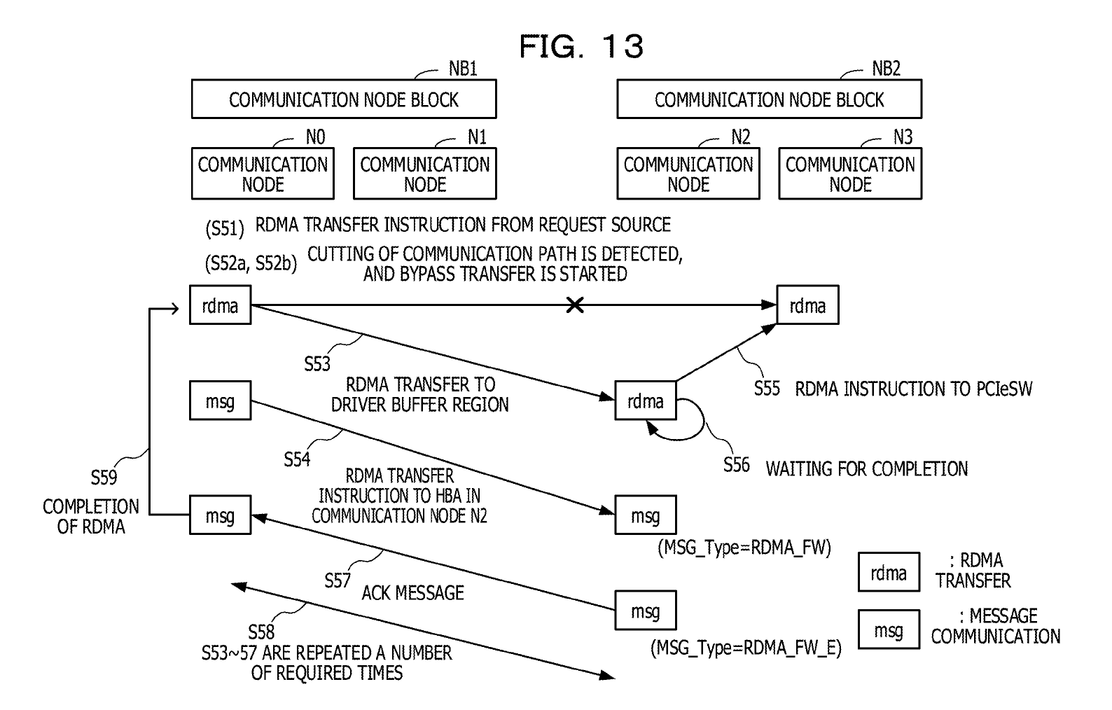

FIG. 13 is a view illustrating an example of a sequence of bypass transfer of RDMA. It is to be noted that “rdma” in FIG. 13 denotes RDMA transfer or a transfer list to be RDMA transferred, and “msg” denotes message communication or a message for the instruction of RDMA transfer.

[Step S51] The communication management unit 10 of the communication node N0 of an RDMA transfer request source instructs the HBA driver unit 12a-2 to perform RDMA transfer toward the HBA driver unit 13b-2 of the communication node N3 (the RDMA does not have a message header).

[Step S52a] The HBA driver unit 12a-2 tries RDMA transfer from the communication node N0 to the communication node N3 through the communication path P13.

[Step S52b] Since the communication path P13 is cut, the communication management unit 10 detects that RDMA transfer using the communication path P13 is not possible and starts bypass transfer.

[Step S53] The HBA driver unit 12a-1 performs RDMA transfer to the driver buffer region r2 of the memory mr2 in the communication node N2.

[Step S54] The communication management unit 10 transmits an RDMA transfer instruction to the HBA driver unit 12a-1 by message communication. At this time, the header part of the message is set, for example, to MSG_Type=RDMA_FW and XID=0x00000002. Further, in the payload of the message of the RDMA transfer instruction, the transfer list is placed.

[Step S55] The communication management unit 12 instructs the PCIeSW driver unit 14b-1 to perform RDMA transfer (no message header for RDMA transfer).

[Step S56] The HBA driver unit 12b-1 performs transfer completion waiting of the PCIeSW driver unit 14b-1.

[Step S57] The HBA driver unit 12b-1 transmits a transfer completion message to the HBA driver unit 12a-1 of the communication node N0. At this time, the message header part is set, for example, to MSG_Type=RDMA_FW_E and XID=0x00000002.

[Step S58] The processes from step S53 to step S57 are carried out by the number of times corresponding to the size of the transfer source list of the RDMA transfer request source.

[Step S59] The HBA driver unit 12a-1 notifies the communication management unit 10 of RDMA transfer completion.

As described above, since the HBA driver unit 12b-1 of the communication node N2 receives a message by reception polling and activates the RDMA of the PCIeSW driver unit 14b-1, a process of higher-level software is not interposed in this part.

It is to be noted that, while, in the foregoing description, message transfer of different types of software is described as message transfer between the HBA and the PCIeSW, the embodiments discussed herein may be applied also to communication devices having different data transfer functions.

As described above, according to the embodiments discussed herein, upon message transfer between driver units of different hardware, a transfer destination driver unit is activated based on an identifier given to the message by a QSTR a thread scheduler includes to perform message transfer. Consequently, the message transfer time period may be reduced. Also such advantageous effects as described below are anticipated.

(1) Since it is made possible to transfer a bypass communication at a high speed, it is possible to reduce components for a redundant path (driver unit and so forth), and reduction in cost of the apparatus may be anticipated.

(2) Since a message crossover between different types of a higher-level software process is not involved, bypass transfer may be implemented by a low latency, and the communication property is increased in speed, and the reception buffer memory for a higher-level software process may be reduced.

(3) Since replacement of software or implantation of a higher-level software process such as revision may not be used, reduction of the development cost may be anticipated.

(4) Since wrapping of a transfer message is not involved, even if a bypass path includes a plurality of nodes, bypass transfer free from speed degradation may be anticipated without changing the message size on the path.

The processing functions of the information processing apparatus 1 and the communication node N in the embodiments discussed herein may be implemented by a computer. In this case, a program that describes the processing substance of the functions the information processing apparatus 1 and the communication node N are to have is provided. The processing functions described above may be implemented by executing the program on a computer.

The program that describes the processing substance may be recorded in a computer-readable recording medium. As the computer-readable recording medium, there are a magnetic storage device, an optical disk, a magneto-optical recording medium, a semiconductor memory and so forth. As the magnetic recording device, there are a hard disk device (HDD), a flexible disk (FD), a magnetic tape and so forth. As the optical disk, there are a DVD, a DVD-RAM, a CD-ROM/RW and so forth. As the magneto-optical recording medium, there are a magneto-optical disk (MO) and so forth.

In order to distribute a program, for example, a portable recording medium such as a DVD or a CD-ROM on which the program is recorded is sold. Also it is possible to store the program on a storage device of a server computer such that the program is transferred from the server computer to a different computer through a network.

A computer that executes a program stores a program, for example, recorded on a portable recording medium or transferred from a server computer into an own storage device. Then, the computer reads the program from the own storage device and executes process in accordance with the program. It is to be noted that also it is possible for a computer to read a program directly from a portable recording medium and execute process in accordance with the program.

Also it is possible for a computer to execute, every time a program is transferred thereto from a server computer coupled thereto though a network, process in accordance with the received program. Also it is possible to implement at least some of the processing functions described hereinabove using an electronic circuit such as a DSP, an ASIC, or a PLD.

Although the embodiments have been described, the components described hereinabove in connection with the embodiments may be replaced by different members having similar functions. Alternatively, some other arbitrary elements or processes may be additionally provided. Furthermore, two or more arbitrary components (features) in the embodiments described above may be used in combination.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first communication device configured to have a first communication driver;
a second communication device configured to have a second communication driver;
a memory; and
a processor coupled to the memory and configured to:
activate the second communication driver based on an identifier of the second communication driver included in a message accepted by the first communication driver, and
transfer the message from the first communication driver to the second communication driver.

2. The information processing apparatus according to claim 1, wherein the processor executes a thread scheduler common to the first communication driver and the second communication driver.

3. The information processing apparatus according to claim 2, wherein the thread scheduler
performs write notification corresponding to the identifier at one end of a waiting structure,
calls a readout notification corresponding to the write notification and waiting at the other end of the waiting structure, and
activates the second communication driver in response to the readout notification.

4. An information processing system for communicating between nodes comprising:
a first node including
a first communication driver of a first communication device,
a first memory, and
a first processor coupled to the memory and configured to
generate a message including an identifier when a communication path failure is detected upon message transfer by the first communication driver, and
transfer the message from the first communication driver through a bypass path;
a second node including
a second communication driver of the first communication device, which is positioned in the bypass path and receives the message, and
a third communication driver of a second communication device, which is positioned on the bypass path and is different from the first communication device;
a second memory; and
a second processor coupled to the second memory and configured to
activate the third communication driver based on the identifier of the third communication driver included in the message such that the message is transferred from the second communication driver to the third communication driver.

5. The information processing system according to claim 4, wherein the second processor executes a thread scheduler common to the second communication driver and the third communication driver.

6. The information processing system according to claim 5, wherein the thread scheduler
performs write notification corresponding to the identifier at one end of a waiting structure,
calls a readout notification corresponding to the write notification and waiting at the other end of the waiting structure, and
activates the third communication driver in response to the readout notification.

7. The information processing system of claim 4, further comprising:
a third node configured to receive the message transferred from the third communication driver through the bypass path,
wherein the first processor executes direct memory access transfer from a first storage unit to a third storage unit of the third node based on the message.

8. An information processing method executed by an information processing apparatus including a first communication device configured to have a first communication driver, a second communication device configured to have a second communication driver, comprising:
activating the second communication driver based on an identifier of the second communication driver included in a message accepted by the first communication driver, and
transferring the message from the first communication driver to the second communication driver.
